(19) United States
(12) Patent Application Publication
(10) Pub. No.: US 2017/0321483 A1
(43) Pub. Date: Nov. 9, 2017

(54) LADDER BUMPER

(71) Applicant: JLS Painting LLC, Meridian, ID (US)

(72) Inventor: John L. Seabold, Meridian, ID (US)

(21) Appl. No.: 15/589,654

(22) Filed: May 8, 2017

Related U.S. Application Data
(60) Provisional application No. 62/333,207, filed on May 7, 2016.

(51) Int. Cl. E06C 7/48

(52) U.S. Cl. CPC E06C 7/48

(57) ABSTRACT

A ladder bumper for use with a ladder. Each ladder bumper comprises a generally U-section rail channel and at least one opposing pair of rung slots in legs in the channel. Each ladder bumper further comprises a generally U-section protective pad, wherein the web portion of the U-section provides a pad web planar surface. Preferably, a pad web thickened portion on the pad web includes an angle-setting protrusion (ASP), the ASP including an ASP planar surface, wherein the ASP planar surface and the pad web planar surface subtend a predetermined ASP angle. The protective pad is received over and affixed snugly to the rail channel. In use, the rail channel of each of a pair of ladder bumpers is received over a corresponding one of the ladder rails and the rung slots are received over selected ladder rungs. The ladder bumpers may then be locked in position with U-bolt locks.

### RELATED APPLICATIONS

This application claims the benefit of, and priority to, commonly-invented and commonly-assigned U.S. Provisional Patent Application Ser. No. 62/333,207, filed May 7, 2016. The entire disclosure of Ser. No. 62/333,207 is incorporated herein by reference.

### FIELD OF THE DISCLOSURE

This disclosure is directed generally to bumpers designed to be affixed to a ladder's rails, and more specifically to a new ladder bumper, embodiments of which assist placement of the ladder at a predetermined and preferably safe vertical angle.

### BACKGROUND OF THE DISCLOSED TECHNOLOGY

Improperly placed ladders can be dangerous to the climber. OSHA requires that a ladder be placed at about 75.5 degrees to the horizontal against a structure for optimum safety against the ladder falling. OSHA further requires that the ladder extend 3 feet past the top step-off point from the ladder (e.g. the roof eave, or roof line, when used to climb onto a conventional building roof). It is not always easy to set the ladder at the correct length to enable the OSHA-recommended horizontal angle and extension. It is further not always easy to estimate visually whether the ladder placement meets the OSHA-recommended horizontal angle and extension. While the placement's horizontal angle and extension can be measured, this can be time consuming and requires “trial and error” until the correct placement is established.

Further, the mere placement of ladders against a structure can cause contact damage to the structure, especially at the point of contact between the ladder and the structure near the top of the ladder. The damage can be made worse if the ladder has to be moved, and sliding occurs at the point of contact between the ladder and the structure. For example, such damage is commonplace when conventional ladders (e.g. wood or aluminum) are used to scale structures such as residential or commercial buildings. Damage may be sustained at contact points such as gutters, walls, window sills, doors or garage doors, for example. Likewise, damage may be sustained during transportation of the ladder in or on a vehicle.

Surfaces on which the bottom of a placed ladder rest may also be potentially unsafe. While surfaces such as concrete are generally satisfactory when other OSHA-recommended parameters are met (e.g. correct horizontal angle and extension), optimum ladder placements do not always provide a bottom surface such as concrete. Soft or uneven surfaces (e.g. unpaved ground) may cause the bottom of a placed ladder to be potentially unstable, calling into the question the entire stability of the ladder in use.

As of the effective filing date of this disclosure, the closest prior art known to Applicant is Published U.S. Patent Application 2013/0239388 to Striepling. The ladder bumpers disclosed in Striepling are disadvantageous in several respects. First, they make no contribution towards OSHA-compliant ladder use. Second, their construction is flimsy and insecure. The buckled ties of Striepling may loosen or wear out. Striepling's bumpers make no use of the inherent strength and stability of the ladder rungs nearby the bumpers' placement. The ladder bumpers of Striepling could thus easily displace relative to the ladder itself, rendering the ladder unstable and prone to falling while a climber was on the ladder.

There is therefore a need for ladder accessories, primarily including a new ladder bumper, that address the foregoing drawbacks of the prior art.

### SUMMARY AND TECHNICAL ADVANTAGES

The needs in the prior art described above in the “Background” section are addressed by a new type of ladder accessory, embodiments of which are set forth in this disclosure. The ladder accessory primarily comprises a new ladder bumper (a pair of which are also sometimes referred to in this disclosure by the brand “Ladder Pals”), embodiments of which are described in this disclosure.

The disclosed ladder bumper encases ladder rails with fitted rung slots and a bumper locking system to give added stability and safety to climber, meeting OSHA requirements, and protecting the structure on which the ladder lays. When a ladder is laid on a structure to extend above a roof line, for example, OSHA requires that the ladder extend 3 feet above the roof line. The disclosed ladder bumpers are easily installed on the selected rungs of a ladder to provide contact points at the roof line while leaving a 3 feet extension of ladder above the roof line. The rung slots on the disclosed ladder bumpers are also advantageously provided at a standard distance apart to accommodate a standard rung spacing on most conventional ladders. OSHA provides that ladder rung spacing should be 12″ or less, and most conventional ladders provide rungs at about 12″ spacing. Similarly, OSHA provides that rung diameter should be ¾″ for metal ladders and 1⅛″ for wooden ladders, and most conventional ladders conform to these standards. The disclosed ladder bumpers provide rung slot dimensions that will slide comfortably over the rungs of most conventional metal or wooden ladders with OSHA-compliant rung diameters. Once the disclosed ladder bumpers are placed over the ladder rails at the desired location and the ladder rungs are engaged in the bumpers' rung slots, the bumper locking system may be engaged to hold the bumpers safely in place during ladder use. In preferred embodiments, the bumper locking system is a conventional U-bolt, where the bolt extends through locking pin holes in the bumpers over the ladder rail to lock the bumpers in place.

When moved, ladders can cause damage to the contact surface against which they are laying or bearing, such as gutters, walls, doors and garage doors. Damage can also be caused to vehicles during transportation. The disclosed ladder bumpers provide protective pads, protecting all surfaces they lay against from contact damage. Advantageously the pads are made from a durable resilient material such as rubber, foam rubber (such as “Styrofoam”), or a suitable elastomer or plastic material, although the scope of this disclosure is not limited to any particular material for pads on the disclosed ladder bumpers.

Embodiments of the disclosed ladder bumpers further provide a ladder angle-setting protrusion (also referred to in this disclosure as an “ASP”) on the protective pads. In such embodiments, the ASP is a thickened portion of the protective pad where a planar surface is provided on the ASP. The planar surface is set at a predetermined angle to the longitudinal axis of the protective pad. Thus, when the disclosed ladder bumpers are installed and engaged on a ladder's rails and rungs, the planar surfaces on the ASPs confront the upper contact surface on the structure against which the ladder is to be laid. The predetermined angle of the planar surface is such that when the planar surface of the ASP is brought into snug contact against the structure's contact surface (assuming the structure's contact surface is substantially vertical), the ladder will be set against the structure at a desired vertical angle. In preferred embodiments, the desired vertical angle will be 75.5 degrees, conforming to OSHA requirements. However, this disclosure is not limited to 75.5 degree deployments, and the ASP on a particular bumper protective pad may be manufactured to set any angle, as required.

The protective pads on the disclosed ladder bumpers may also, in some embodiments, be textured to provide additional slip resistance. It is well understood that one of the dangers of ladder use is that the ladder may slip or slide horizontally against its upper contact surface and fall while a climber is on the ladder. This is particularly the case if the ladder is not (or not yet) tied off or otherwise secured at the top end. The durable resilient material from which the Ladder Pals protective pads are made will inherently provide slip resistance against contact surfaces. Embodiments in which the protective pads are textured will provide additional slip resistance.

The disclosed ladder bumpers may also be installed on the legs of a step ladder to protect surrounding surfaces (such as walls, doors, etc.) from accidental “knocks” and “bumps” while moving the step ladder. It is well known that step ladders have to be moved carefully in confined spaces to avoid such accidental contact damage. The disclosed ladder bumpers can be installed on the legs of a step ladder and the protective pads on the bumpers will cushion against potential damage to surrounding structures caused when the step ladder is moved.

The disclosed ladder bumpers also optionally include ladder stakes. Ladder stakes also help with stability. They stabilize ladders on hill sides and on surfaces other than concrete or rock. This is added protection for the climber. The stakes reduce the risk of injury if climber is climbing alone. They can also be manufactured to assist with setting the ladder at a desired vertical angle for safe ladder placement.

Climber safety is further enhanced by the secure and robust manner in which the disclosed ladder bumpers engage a ladder. Conventional products, such as disclosed in Striepling, described above in the “Background” section, are flimsy and unreliable. Straps on conventional bumpers can loosen, can impede climbing, and may even shift relative to the ladder, rendering the ladder unstable in place and therefore unsafe. If a climber starts to lose balance and grabs onto one or both of the disclosed ladder bumpers, however, the bumper(s) will not separate from the ladder, or shift, move or rotate in any way relative to the ladder, thereby adding to the safety of the product.

In a first aspect, therefore, this disclosure describes a ladder bumper comprising: a rail channel, the rail channel having first and second rail channel ends, the rail channel further having two generally opposing and parallel channel legs separated by and connected to a channel web; at least one opposing pair of rung slots, wherein one rung slot in each opposing pair thereof is provided in a corresponding channel leg, each rung slot providing a rung slot opening, wherein opposing pairs of rung slots follow a path from their rung slot openings generally in the direction of the first rail channel end; a protective pad, the protective pad having first and second protective pad ends, the protective pad having a generally U-shaped cross section in which the protective pad has two generally opposing and parallel pad legs separated by and connected to a pad web, wherein the pad web provides a pad web planar surface; a pad web thickened portion provided on the pad web towards the first protective pad end, the pad web thickened portion including an angle-setting protrusion (ASP), the ASP including an ASP planar surface, wherein the ASP planar surface and the pad web planar surface subtend a predetermined ASP angle; and wherein the protective pad is received over and affixed snugly to the rail channel such that the pad web contacts the channel web and the first protective pad end is oriented towards the first rail channel end.

In embodiments according to the first aspect, the predetermined ASP angle on each ladder bumper is selected to be about 14.5 degrees. The ladder bumper may also include at least one pair of opposing locking pin holes, one locking pin hole in each opposing pair thereof provided in a corresponding channel leg. One U-bolt lock may be assigned to each pair of opposing locking pin holes, each U-bolt lock configured to be concurrently received through both locking pin holes in its assigned opposing pair thereof. The ASP planar surface may be textured.

In a second aspect, this disclosure describes a pair of ladder bumpers and a ladder, the ladder including two ladder rails separated by a plurality of spaced-apart ladder rungs, each ladder bumper comprising: a rail channel, the rail channel having first and second rail channel ends, the rail channel further having two generally opposing and parallel channel legs separated by and connected to a channel web; at least one opposing pair of rung slots, wherein one rung slot in each opposing pair thereof is provided in a corresponding channel leg, each rung slot providing a rung slot opening, wherein opposing pairs of rung slots follow a path from their rung slot openings generally in the direction of the first rail channel end; a protective pad, the protective pad having first and second protective pad ends, the protective pad having a generally U-shaped cross section in which the protective pad has two generally opposing and parallel pad legs separated by and connected to a pad web, wherein the pad web provides a pad web planar surface; a pad web thickened portion provided on the pad web towards the first protective pad end, the pad web thickened portion including an angle-setting protrusion (ASP), the ASP including an ASP planar surface, wherein the ASP planar surface and the pad web planar surface subtend a predetermined ASP angle; and wherein the protective pad is received over and affixed snugly to the rail channel such that the pad web contacts the channel web and the first protective pad end is oriented towards the first rail channel end; wherein the rail channel of each ladder bumper is received over a corresponding one of the ladder rails and the rung slots in one of the channel legs of each ladder bumper are received over corresponding selected ones of the ladder rungs.

In further embodiments according to the second aspect, the predetermined ASP angle on each ladder bumper may preferably be selected to be about 14.5 degrees, wherein when the ladder is stood upright on a substantially horizontal base surface such that the ASP planar surface on each ladder bumper is brought into snug contact with a substantially vertical surface, the ladder rails and the base surface subtend a ladder angle of about 75.5 degrees. Each ladder bumper may further include at least one pair of opposing locking pin holes, one locking pin hole in each opposing pair thereof provided in a corresponding channel leg; and at least one U-bolt lock, one U-bolt lock assigned to each pair of opposing locking pin holes, each U-bolt lock configured to be concurrently received through both locking pin holes in its assigned opposing pair thereof; wherein each U-bolt lock as received through its corresponding opposing pair of locking pin holes further secures each ladder bumper to its corresponding ladder rail. The pair of ladder bumpers and ladder may further include a ladder stake, the ladder stake configured anchor one of the ladder rungs to a base surface when the ladder is stood upright on the base surface.

It is therefore a technical advantage of the disclosed ladder bumpers to enhance climber safety. Aspects and features of the disclosed bumpers enhance climber safety generally. Embodiments of the disclosed bumpers may further assist with, and even encourage, compliant OSHA ladder use.

A further technical advantage is that the disclosed ladder bumpers reduce greatly (and even prevent) contact wear or damage to surfaces on structures against which the ladder lays or rests.

The foregoing has rather broadly outlined some features and technical advantages of the disclosed ladder bumpers, in order that the following detailed description may be better understood. Additional features and advantages of the disclosed technology may be described. It should be appreciated by those skilled in the art that the conception and the specific embodiments disclosed may be readily utilized as a basis for modifying or designing other structures for carrying out the same inventive purposes of the disclosed technology, and that these equivalent constructions do not depart from the spirit and scope of the technology as described and as recited in the accompanying claims.

### BRIEF DESCRIPTION OF THE DRAWINGS

For a more complete understanding of the embodiments described in this disclosure, and their advantages, reference is made to the following detailed description taken in conjunction with the accompanying drawings, in which:

FIGS. 1A, 1B and 1C illustrate various views of an embodiment of protective pad 100 including angle-setting protrusion (“ASP”) 110;

FIGS. 2A and 2B illustrate protective pad 100 as shown in FIGS. 1A through 1C in assembly with rail channel 200;

FIG. 3 illustrates two different embodiments of protective pad 100 and 100A, including different embodiments of ASP 110 and 110A;

FIGS. 4A and 4B illustrate rail channel 200A, an alternative embodiment to rail channel 200 in assembly with protective pad 100;

FIG. 5 illustrates one embodiment of a suitable U-bolt lock 300;

FIG. 6 illustrates deployment of the disclosed ladder bumpers on a conventional ladder in which ASP 112 operates to set the desired ladder angle 119;

FIG. 6A is an exploded isometric view of the base of FIG. 6 showing insertion of ladder stake 400 in more detail; and

FIGS. 7A and 7B illustrate an embodiment of the disclosed ladder bumper in use with a conventional ladder.

### DETAILED DESCRIPTION

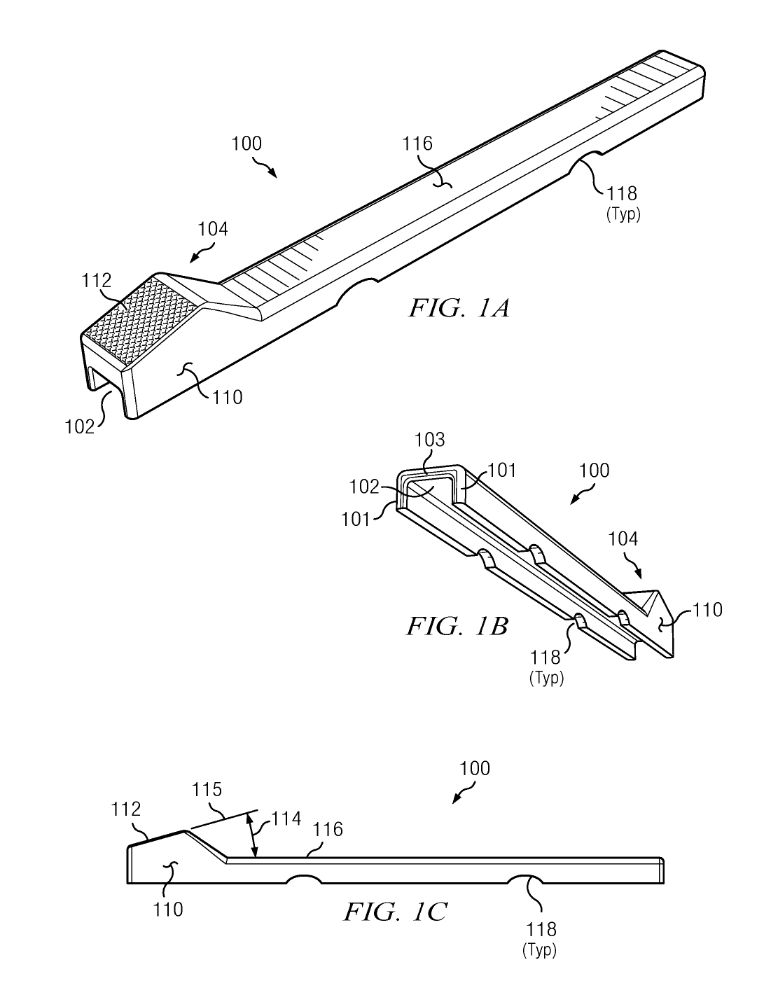

Reference is now made to FIGS. 1 through 7B in describing the currently preferred embodiments of the disclosed ladder bumper. FIGS. 1 through 7B should be viewed together. Any part, item, or feature that is identified by part number on one of FIGS. 1 through 7B has the same part number when illustrated on another of FIGS. 1 through 7B.

FIGS. 1A, 1B and 1C illustrate various views of an embodiment of protective pad 100. FIG. 1B depicts protective pad 100 having a generally U-shaped cross section in which two generally opposing and parallel pad legs 101 are separated by and connected to pad web 103. FIG. 1B also shows recess 102 formed by pad legs 101 and pad web 103. As shown on FIGS. 1A and 1C, pad web 103 provides a pad web planar surface 116. FIGS. 1A and 1B depict protective pad 100 having first and second protective pad ends, with a pad web thickened portion 104 provided on pad web 103 towards the first protective pad end. Referring now to FIGS. 1A and 1C, pad web thickened portion 104 includes an angle-setting protrusion (ASP) 110. ASP 110 includes ASP planar surface 112, such that ASP planar surface 112 and pad web planar surface 116 subtend a predetermined ASP angle 114.

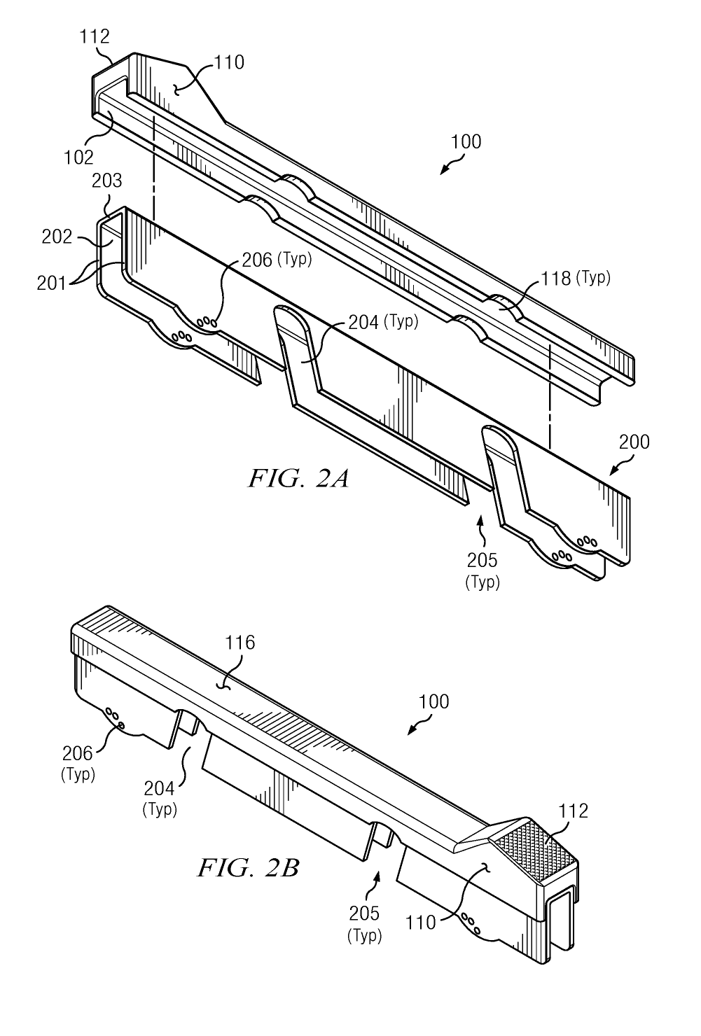

Referring now to FIG. 2A, an exploded view of protective pad 100 and rail channel 200 is depicted. Similar to protective pad 100 as described above, rail channel 200 rail channel has a generally U-shaped cross section in which two generally opposing and parallel channel legs 201 are separated by and connected to a channel web 203. Channel space 202 is formed by channel legs 201 and channel web 103. FIG. 2A further depicts rail channel 200 having first and second rail channel ends such that the first protective pad end on protective pad 100 is oriented towards the first rail channel end on rail channel 200.

In the embodiment illustrated on FIGS. 2A and 2B, rail channel 200 provides two opposing pairs of rung slots 204. One rung slot 204 in each opposing pair thereof is provided in a corresponding channel leg 201. Each rung slot 204 further provides a rung slot opening 205, such that opposing pairs of rung slots 204 follow a path from their rung slot openings 205 generally in the direction of the first rail channel end.

FIG. 2B illustrates protective pad 100 received over and affixed snugly to rail channel 200 such that (with additional reference to FIG. 2A) pad web 103 contacts channel web 203.

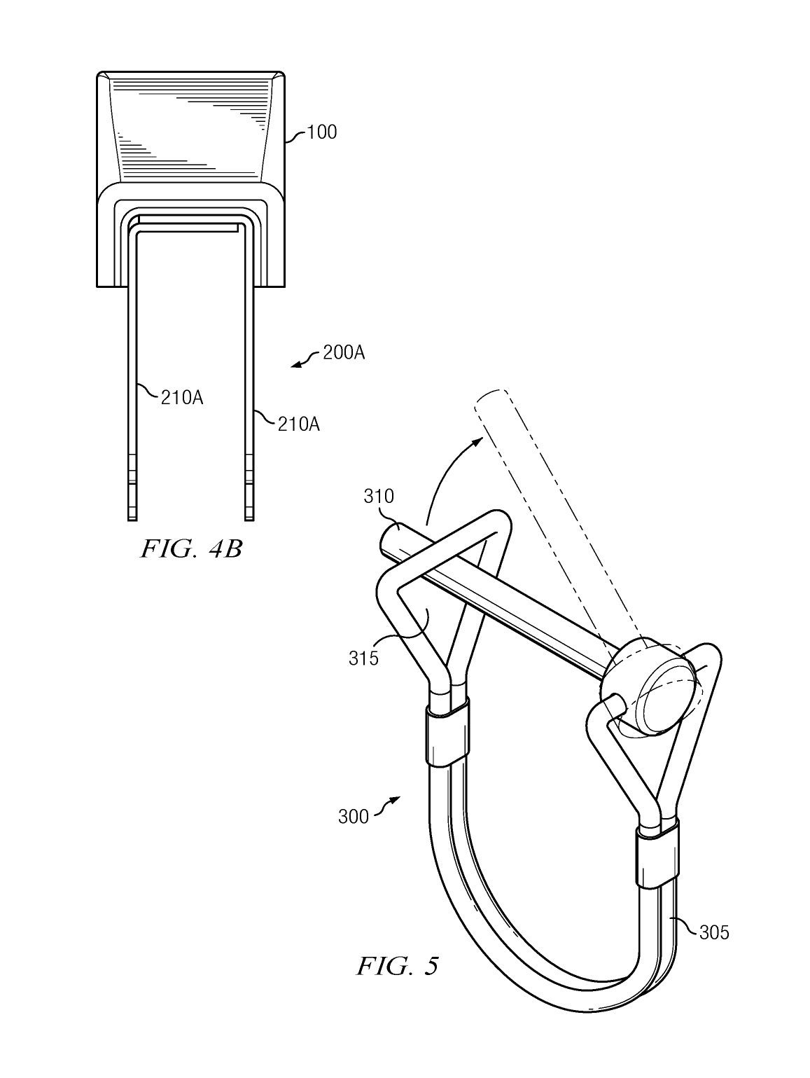

Referring to the embodiments illustrated on FIGS. 2A and 2B in more detail, rail channel 200 may be any suitable generally u-shaped profile member, or a combination of members. This disclosure is not limited to any particular construction of rail channel 200, and may be for example, a unitary channel member, or an assembly of 2 angle members (an example of which is described below with reference to FIGS. 4A and 4B), or another design. Rail channel 200 is preferably made of metal, and more preferably aluminum, although again this disclosure is not limited in this regard. Other materials for rail channel 200 may be suitable, depending on application and user design. Preferably, the width and depth of channel space 202 in rail channel 200 is selected so that rail channel 200 slides comfortably over the rail of a conventional ladder.

As depicted on FIG. 2A, preferably two opposing pairs of rung slots 204 (i.e. four rung slots 204 total) are provided in channel legs 201 for engagement either side of two adjacent rungs on a conventional ladder. Two opposing pairs of rung slots 204 offer optimum stability when engaged on a ladder in view of design length and weight of the rail channel 200. However, this disclosure is not limited in this regard. Two rung slots 204 (engaging either side of one rung) may be provided in other embodiments, or six or more (engaging either side of three or more rungs) may be provided in yet further embodiments, depending on user design. Similarly, although the embodiment illustrated on FIG. 2A provides rung slots 204 for adjacent ladder rungs, this disclosure is not limited to adjacent ladder rungs. The scope of this disclosure includes other embodiments where rung slots 204 engage ladder rungs that are not adjacent.

It will be further appreciated from FIG. 2A that the path of rung slots 204 is preferably straight, and shaped to follow a direction from rung slot openings 205 towards the first rail channel end. Preferably, this allows rung slots 204 to fully engage the ladder rungs and then to be secured in place in part by gravitational force when the ladder is upright. This feature enhances the stability and locking advantage of the disclosed ladder bumper when in use on an upright ladder. The scope of this disclosure is not limited, however, to particular paths that rung slots 204 may follow in channel legs 201, and alternative embodiments (not illustrated) may include straight or curved paths, all preferably following a direction from rung slot openings 205 towards the first rail channel end.

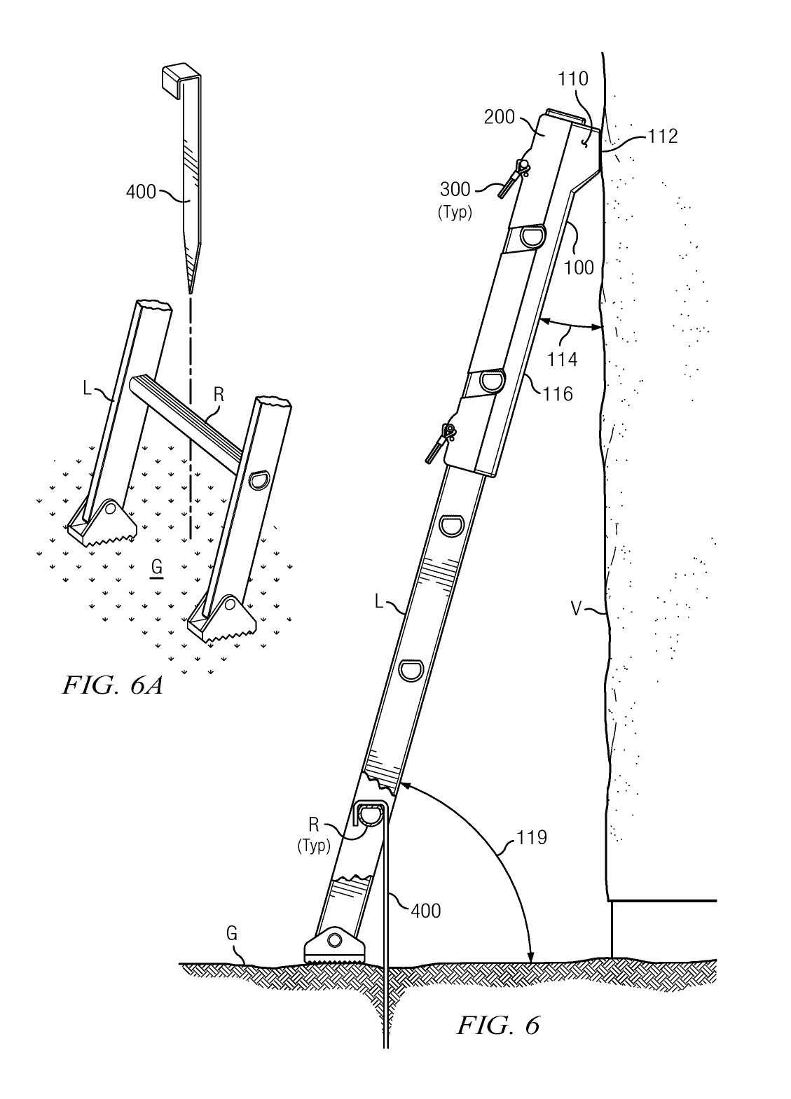

FIGS. 2A and 2B further illustrate locking pin holes 206 provided in rail channel 200. Locking pin holes 206 are configured to receive U-bolt locks (described below with reference to FIG. 5) in order to retain rail channel 200 on the ladder rail once rail channel 200 is fully engaged on the ladder rail and rungs. Preferably, locking pin holes 206 are provided in a group, allowing a user to select an optimum locking pin hole 206 through which to receive the U-bolt lock according to the individual fit of rail channel 200 over a particular ladder rail.

As noted above, FIG. 2A illustrates protective pad 100 in exploded view with rail channel 200, and FIG. 2B illustrates protective pad 100 received over and affixed snugly to rail channel 200. Fixation of protective pad 100 to rail channel 200 may be by any conventional technique, such as with adhesive and/or with fasteners, for example. This disclosure is not limited in this regard. As shown on FIGS. 2A and 2B, recess 102 in protective pad 100 mates with channel web 203 and portions of channel legs 201. Where needed, protective pad 100 also provides cutouts 118 to cooperate with rung slots 204 on rail channel 200, to ensure that protective pad 100 does not impede full engagement of the ladder rungs on rung slots 204. As described above in the “Summary” section, this disclosure is not limited to any particular selection of materials for protective pad 100, although preferably the material will be resilient and durable, such as, for example, rubber or Styrofoam.

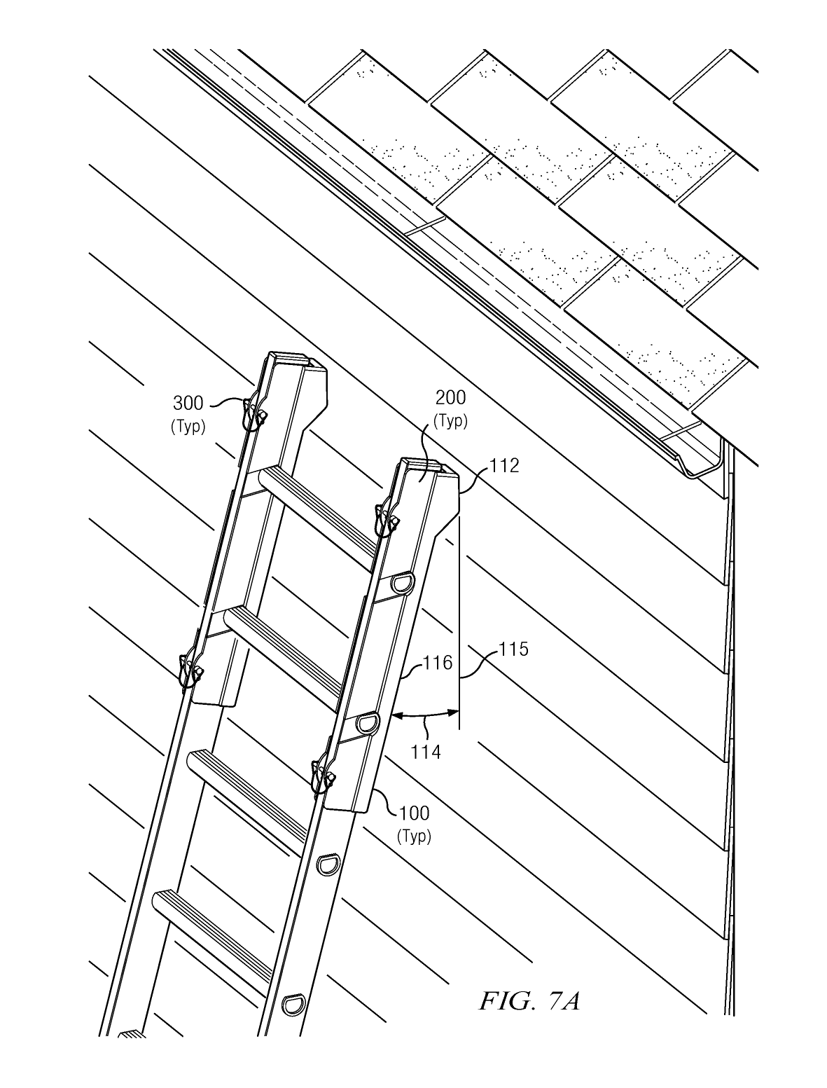

With reference now to FIG. 6, and as described generally in the “Summary” section above, the disclosed ladder bumpers are shown installed and engaged on a ladder's rails L and rungs R. Planar surfaces 112 on ASPs 110 confront a substantially vertical upper contact surface V on the structure against which the ladder is to be laid. The ladder is standing on a substantially horizontal ground surface G. From FIG. 1C, the predetermined ASP angle 114 on ASP 110 on FIG. 6 is now such that when planar surface 112 is brought into snug contact against the structure's contact surface V, the ladder will be set against the structure at a user-desired ladder angle 119. The value of ladder angle 119 will be about [90°—ASP angle 114]. In preferred embodiments, predetermined ASP angle 114 is about 14.5°, so that ladder angle 119 is about 75.5°, conforming to OSHA requirements. However, this disclosure is not limited to 14.5°/75.5° deployments for ASP angle 114 and ladder angle 119, and ASP 110 on a particular protective pad 100 may be manufactured to set any predetermined ASP angle 114, as required.

FIGS. 6 and 6A further illustrate the use of ladder stake 400 over rung R to anchor the ladder in place in ground G (where ground G is soft enough to receive ladder stake 400). Preferably, ladder stake 400 is installed once the desired ladder angle 119 has been set.

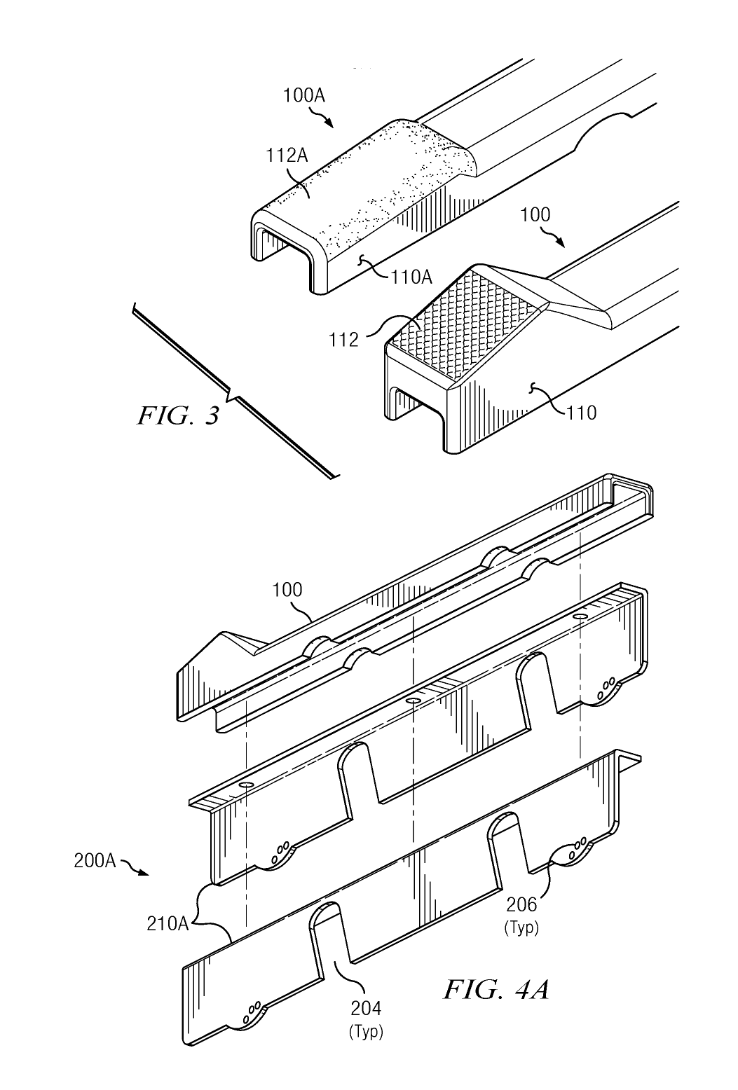

FIG. 3 illustrates two different embodiments of protective pad 100 (labeled 100 and 100A) with different dimensions, both overall in the protective pad 100/100A, and also on ASP 110/110A. FIG. 3 also illustrates that surfaces on protective pad 100/100A, including planar surface 112/112A, may be textured to offer additional slip resistance.

FIGS. 4A and 4B depict views of rail channel 200A, an exemplary alternative two-piece construction of rail channel 200 illustrated on FIGS. 2A and 2B. Per disclosure above associated with FIG. 2A, rail channel 200 may be any suitable generally u-shaped profile member, or combination of members, and this disclosure is not limited to any particular construction of rail channel 200. FIGS. 4A and 4B depict embodiments of rail channel 200A constructed from two angle members 210A fixed together by fasteners.

FIG. 5 illustrates one embodiment of a conventional U-bolt lock 300 that may be used in conjunction with locking pin holes 206 on rail channel 200 as illustrated on FIGS. 2A and 2B. In the embodiment of FIG. 5, U-bolt lock 300 comprises U-bolt frame 305, which may be manually widened (against spring bias provided by frame 305) to allow insertion or removal of U-bolt pin 310 into or out of U-bolt hole 315. U-bolt locks 300 are commercially available from well-known fastener suppliers such as McMaster-Carr. It will be nonetheless appreciated that this disclosure is not limited to the illustrated embodiment of U-bolt locks 300, and that any suitable conventional fastener may be used to lock rail channel 200 in place on the ladder rail.

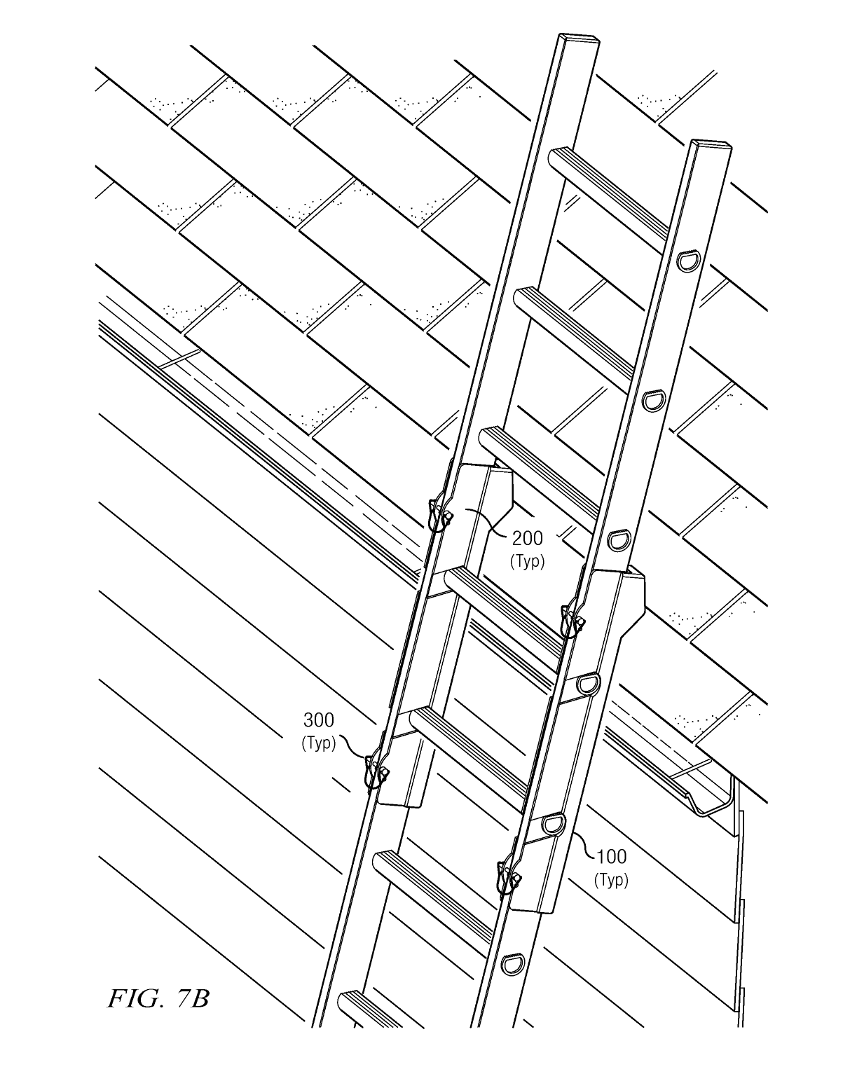

FIGS. 7A and 7B illustrate embodiments of the disclosed ladder bumpers in use on a conventional ladder. With additional reference to FIGS. 5 and 2A, it will be seen on FIGS. 7A and 7B that once the disclosed ladder bumpers are fully engaged on the ladder rungs and around the ladder rail, U-bolt pins 310 on U-bolt locks 300 may be passed through locking pin holes 206 on rail channel 200, thereby securely locking the ladder bumpers onto the ladder in the desired location. The U-bolt frame 305 of U-bolt lock 300 may also be used as a handle to assist manual fastening and unfastening of U-bolt lock 300. In embodiments using a U-bolt lock 300, once the bolt is fastened to secure rail channel 200, U-bolt frame 305 may then be laid down to rest flush against the ladder rail during ladder use.

FIGS. 7A and 7B further illustrate different positions on the ladder that the disclosed ladder bumpers may be located according to the needs of the job. On FIG. 7A, the disclosed ladder bumpers are located near the top end of the ladder, providing protection when the contact surface is, for example, the vertical side of a structure. On FIG. 7B, the disclosed ladder bumpers are located further down towards the base of the ladder, when the contact surface is a roof line or a garage door, for example, where the ladder will extend further upwards past the contact surface. FIG. 7A also illustrates the subtending of predetermined ASP angle 114 between ASP plane 115 and pad web planar surface 116 per earlier disclosure with reference to FIG. 1C and FIG. 6.

Although the disclosed ladder bumpers and their advantages have been described in detail, it should be understood that various changes, substitutions and alternations can be made herein without departing from the spirit and scope of the technology as defined by the appended claims.

I claim:

1. A ladder bumper, comprising:
a rail channel, the rail channel having first and second rail channel ends, the rail channel further having two generally opposing and parallel channel legs separated by and connected to a channel web;
at least one opposing pair of rung slots, wherein one rung slot in each opposing pair thereof is provided in a corresponding channel leg, each rung slot providing a rung slot opening, wherein opposing pairs of rung slots follow a path from their rung slot openings generally in the direction of the first rail channel end;
a protective pad, the protective pad having first and second protective pad ends, the protective pad having a generally U-shaped cross section in which the protective pad has two generally opposing and parallel pad legs separated by and connected to a pad web, wherein the pad web provides a pad web planar surface;
a pad web thickened portion provided on the pad web towards the first protective pad end, the pad web thickened portion including an angle-setting protrusion (ASP), the ASP including an ASP planar surface, wherein the ASP planar surface and the pad web planar surface subtend a predetermined ASP angle; and
wherein the protective pad is received over and affixed snugly to the rail channel such that the pad web contacts the channel web and the first protective pad end is oriented towards the first rail channel end.

2. The ladder bumper of claim 1, in which the predetermined ASP angle on each ladder bumper is selected to be about 14.5 degrees.

3. The ladder bumper of claim 1, further including at least one pair of opposing locking pin holes, one locking pin hole in each opposing pair thereof provided in a corresponding channel leg.

4. The ladder bumper of claim 3, further including at least one U-bolt lock, one U-bolt lock assigned to each pair of opposing locking pin holes, each U-bolt lock configured to be concurrently received through both locking pin holes in its assigned opposing pair thereof.

5. The ladder bumper of claim 1, in which the ASP planar surface is textured.

6. A ladder bumper, comprising:
a rail channel, the rail channel having first and second rail channel ends, the rail channel further having two generally opposing and parallel channel legs separated by and connected to a channel web;
at least one opposing pair of rung slots, wherein one rung slot in each opposing pair thereof is provided in a corresponding channel leg, each rung slot providing a rung slot opening, wherein opposing pairs of rung slots follow a path from their rung slot openings generally in the direction of the first rail channel end; and
a protective pad, the protective pad having first and second protective pad ends, the protective pad having a generally U-shaped cross section in which the protective pad has two generally opposing and parallel pad legs separated by and connected to a pad web;
wherein the protective pad is received over and affixed snugly to the rail channel such that the pad web contacts the channel web and the first protective pad end is oriented towards the first rail channel end.

7. The ladder bumper of claim 6, in which the pad web provides a pad web planar surface, the ladder bumper further including a pad web thickened portion provided on the pad web towards the first protective pad end, the pad web thickened portion including an angle-setting protrusion (ASP), the ASP including an ASP planar surface, wherein the ASP planar surface and the pad web planar surface subtend a predetermined ASP angle.

8. The ladder bumper of claim 7, in which the predetermined ASP angle on each ladder bumper is selected to be about 14.5 degrees.

9. The ladder bumper of claim 6, further including at least one pair of opposing locking pin holes, one locking pin hole in each opposing pair thereof provided in a corresponding channel leg.

10. The ladder bumper of claim 9, further including at least one U-bolt lock, one U-bolt lock assigned to each pair of opposing locking pin holes, each U-bolt lock configured to be concurrently received through both locking pin holes in its assigned opposing pair thereof.

11. The ladder bumper of claim 7, in which the ASP planar surface is textured.

12. A pair of ladder bumpers and a ladder, the ladder including two ladder rails separated by a plurality of spaced-apart ladder rungs, each ladder bumper comprising:
a rail channel, the rail channel having first and second rail channel ends, the rail channel further having two generally opposing and parallel channel legs separated by and connected to a channel web;
at least one opposing pair of rung slots, wherein one rung slot in each opposing pair thereof is provided in a corresponding channel leg, each rung slot providing a rung slot opening, wherein opposing pairs of rung slots follow a path from their rung slot openings generally in the direction of the first rail channel end;
a protective pad, the protective pad having first and second protective pad ends, the protective pad having a generally U-shaped cross section in which the protective pad has two generally opposing and parallel pad legs separated by and connected to a pad web, wherein the pad web provides a pad web planar surface;
a pad web thickened portion provided on the pad web towards the first protective pad end, the pad web thickened portion including an angle-setting protrusion (ASP), the ASP including an ASP planar surface, wherein the ASP planar surface and the pad web planar surface subtend a predetermined ASP angle; and
wherein the protective pad is received over and affixed snugly to the rail channel such that the pad web contacts the channel web and the first protective pad end is oriented towards the first rail channel end,
wherein the rail channel of each ladder bumper is received over a corresponding one of the ladder rails and the rung slots in one of the channel legs of each ladder bumper are received over corresponding selected ones of the ladder rungs.

13. The pair of ladder bumpers and ladder of claim 12, in which the predetermined ASP angle on each ladder bumper is selected to be about 14.5 degrees, wherein when the ladder is stood upright on a substantially horizontal base surface such that the ASP planar surface on each ladder bumper is brought into snug contact with a substantially vertical surface, the ladder rails and the base surface subtend a ladder angle of about 75.5 degrees.

14. The pair of ladder bumpers and ladder of claim 12, in which each ladder bumper further includes:
at least one pair of opposing locking pin holes, one locking pin hole in each opposing pair thereof provided in a corresponding channel leg; and
at least one U-bolt lock, one U-bolt lock assigned to each pair of opposing locking pin holes, each U-bolt lock configured to be concurrently received through both locking pin holes in its assigned opposing pair thereof;
wherein each U-bolt lock as received through its corresponding opposing pair of locking pin holes further secures each ladder bumper to its corresponding ladder rail.

15. The pair of ladder bumpers and ladder of claim 12, further including a ladder stake, the ladder stake configured anchor one of the ladder rungs to a base surface when the ladder is stood upright on the base surface.

16. The ladder bumper of claim 12, in which the ASP planar surface is textured.
